(19) United States
(12) Patent Application Publication
(10) Pub. No.: US 2010/0140502 A1
(43) Pub. Date: Jun. 10, 2010

(54) OXYGEN SENSITIVE MATERIAL, SENSORS, SENSOR SYSTEMS WITH IMPROVED PHOTOSTABILITY

(76) Inventors: Adrian Guckian, Dunboyne (IE); Maja Dyson, Dunboyne (IE)

Correspondence Address: BROWN RUDNICK LLP, ONE FINANCIAL CENTER, BOSTON, MA, 02111, US

(21) Appl. No.: 12/515,701

(22) PCT Filed: Nov. 20, 2007
(86) PCT No.: PCT/IB2007/004639

§ 371 Date: Feb. 18, 2010

Related U.S. Application Data
(60) Provisional application No. 60/860,164, filed on Nov. 20, 2006.
(60) Provisional application No. 60/897,084, filed on Jan. 24, 2007.
(60) Provisional application No. 60/898,510, filed on Jan. 31, 2007.
(60) Provisional application No. 60/903,939, filed on Feb. 28, 2007.
(60) Provisional application No. 60/904,105, filed on Mar. 1, 2007.

(51) Int. Cl. G01J 1/58; B32B 27/32; B32B 27/30; B32B 27/34; B32B 27/40; B32B 9/00; C08K 5/3437

(52) U.S. Cl. 250/459.1; 428/523; 428/474.4; 428/423.1; 428/447; 250/458.1; 524/89

(57) ABSTRACT

An oxygen sensitive polymeric material with enhanced photostability, comprising an oxygen sensitive indicator and photostabilizer incorporated into an oxygen permeable polymeric material is provided. The oxygen sensitive indicator can be, but is not limited to, [Ru(L1)(L2)(L3)]²⁺, wherein Ru represents the central ruthenium ion, L1, L2 and L3 represent the bidentate ligands diphenylphenanthroline, phenanthroline or bipyridine ligands or optionally substituted variations of same with representative counter ions selected from (PF6)—, Cl—, BF4—, Br— and (C 104)—, platinum or palladium based metallo-porphyrin. The photostabilizer is selected from CIBA TINUVIN 5236, TINUVIN 292, TINUVIN 123 and TINUVIN 272, TINUVIN 477W, DABCO and ascorbic acid. A sensor system for detecting oxygen and a method for detecting oxygen in a package is also provided.

### CROSS-REFERENCE TO RELATED APPLICATIONS

This patent application claims priority to U.S. Provisional Patent Application No. 60/860,164, filed Nov. 20, 2006; U.S. Provisional Patent Application No. 60/897,084, filed Jan. 24, 2007; U.S. Provisional Patent Application No. 60/898,510, filed Jan. 31, 2007; U.S. Provisional Patent Application No. 60/904,105, filed Feb. 28, 2007 and U.S. Provisional Patent Application No. 60/903,939 filed Feb. 28, 2007, the entire contents of each are incorporated herein by reference.

### BACKGROUND

1. Technical Field

The present disclosure generally relates to oxygen sensors, more particularly, to a method of making oxygen sensitive plastics and to the manufacture and use of such oxygen sensitive plastics.

2. Description of the Related Art

Modified Atmosphere Packaging (MAP) has been used since the mid 1950s and has steadily increased as a viable method of extending the shelf life of a wide variety of different products. Many industries incorporating MAP use materials that provide a barrier between the product and the external atmosphere as many of these products may become spoiled or degrade in the presence of oxygen. Products that require such packaging include pharmaceuticals, food, medical devices or medical supplies. Due to the importance of the integrity of the packaging, it is imperative to detect any leaks in the packages to prevent spoilage or destruction of the product.

Generally, oxygen monitoring within packaging has required extensive testing and gas-sampling techniques. The standard method currently used to check the integrity of MAP involves the use of a MAP analyzer instrument. This involves piercing the package using a needle probe to withdraw a sample of the protective gas atmosphere. The gas is then analysed using an electrochemical sensor (e.g. PBI-Densor MAP Check Combi) to determine the oxygen concentration. As this is a destructive method, only a small percentage of the packages can be tested and so 100% Quality Control (QC) is not possible. If a package is found to be leaking or not sealed correctly, what follows is a time consuming and costly process of back-checking and repacking. (e.g. PBI-Densor MAP Check Combi).

There are many visual sensors available for food packaging that have been made available that are visual indicators in the form of inserts but are not very accurate.

The incorporation of Ruthenium dye brings the problem of photo-bleaching (photo-degradation) of the dye. U.S. Pat. No. 6,689,438 to Kennedy et al. provides for the use of ruthenium dyes in an oxygen detection system for a solid article that follows the oxygen consumption of a scavenger within a laminate layer of a food package. Another example of the use of using ruthenium complex to measure the oxygen concentration non-invasively inside a food pack is described in U.S. Pat. No. 6,664,111 to Bentsen et al. Fluorescence Based Oxygen Sensor Systems. The use of these systems are limited to short term uses, due to the natural photobleaching of the ruthenium complex in the presence of light, and therefore these solutions do not typically provide an ability to measure the oxygen concentration at each stage of the supply chain.

It is known that dye molecules fade under the influence of light, however, the rate of fading can vary greatly. Photo-bleaching refers to any photochemical transformation of a dye molecule which precludes their primary function, in our case their luminescence which is used to measure the O₂ concentration via the fluorescence quenching mechanism. The photochemistry of ruthenium complexes in solution is dominated by ligand loss and replacement of one or more ligands by solvent molecules or counter ions.

It is believed photo-bleaching of many dyes affects only their emission intensities but not the decay time parameters (time constants, phase-shifts, or Stern-Volmer quenching constants), provided that photoproducts are non-emissive and there are no photo-induced changes in the dye's microenvironment (dye molecules and polymer's segments nearby). However, in addition to expected decrease of intensity upon illumination by light, it has been observed that oxygen sensors made with ruthenium dyes show also a decrease of decay time parameters (e.g. phase shift) upon photo-bleaching. The conditions that can influence the photo-effects on decay-time parameters are: irradiance with light, presence of oxygen, type of polymer, high dye concentration and type of dye.

Use of anti-fading media for retardation of fluorescence fading in fluorescence microscopy has been used for several decades. It is known that several mechanisms of physical and chemical scavenging of singlet oxygen can be very effective in protecting both the polymer matrix and the dye from photobleaching. Photostabilizers such as 1-4-diazabicyclo(2,2,2)-octane (DABCO) are used to slow down the effect of photobleaching due to continuous exposure to a light source in correlative microscopy. In plastics and in the ink-jet industry photostabilizers are used to slow down the photo-degradation of polymers and to stabilize the colorant dye. They can be divided into hindered amine light stabilizers (HALS) that act by scavenging the radical intermediates formed in the photo-oxidation process and UV absorbers (UVAs) that act by shielding the polymer from ultraviolet light. For example, U.S. Pat. No. 7,0634,18 to Sen et al. uses monomeric and oligomeric additives (HALS and UVAs) to stabilize dyes in porous ink-jet media.

### SUMMARY

Thus, it is necessary to provide an oxygen sensitive material and oxygen sensitive system that is cost effective and that can be used without breaching the seal integrity of the package. It is also desirable to provide an oxygen sensitive package with increased photostability. Accordingly, disclosed within are methodologies for the manufacture of oxygen sensitive materials and sensor elements and oxygen sensitive materials with improved photostability. Further, the non-invasive use of an oxygen sensor system to detect and measure concentrations of oxygen in gases in enclosed spaces, particularly gases enclosed in modified atmosphere packages containing such items as food, cosmetics, medical devices and pharmaceuticals is disclosed. Accordingly, the present disclosure proposes the use of the packaging material or a layer of the packaging material itself as the sensing element. Methodologies for the manufacture of these oxygen sensitive polymeric materials with improved photostability are disclosed.

In addition, methodologies for the manufacture and use of oxygen sensitive polymeric films, sheets and molded plastics of any shape having improved photostability, hereafter oxygen sensitive plastics that can be used directly as oxygen sensors, or as oxygen sensitive packaging materials, or as an oxygen sensitive layer within a laminate construction and methods for determining the concentration of oxygen in a medium using the oxygen sensitive plastics are described.

It was found that the addition of photostabilizers with the oxygen sensitive indicator significantly reduced the detrimental effect that light has on the performance of the oxygen sensitive plastic and materially extended the stable workable shelf life time of the oxygen sensitive plastics. The use of photostabilizers extended the stable life time by approximately 300%. Accordingly, the use of an optical oxygen sensor system utilizing oxygen sensitive materials with improved photostability to detect and measure non-invasively concentrations of oxygen in gases in enclosed spaces, particularly gases enclosed in modified atmosphere packaged packages, containing items including but not limited to gases, food, cosmetics, medical devices and pharmaceuticals is disclosed.

The optical oxygen sensor system utilizing the oxygen sensitive plastic provides accurate, reliable, economical and reproducible oxygen concentration determinations in commercial packaging environments and applications. The invention is especially useful in providing quality control checks on package seal integrity and on the makeup and quality of modified atmospheres and vacuums in sealed packages, bottles, vials and containers. In addition, because of its non-invasive nature, the optical oxygen sensor system can be used effectively and economically on 100% of packaging in lieu of currently utilized statistical sampling quality control checking methods. Further, the optical oxygen sensor system maybe utilized over the shelf life of the package as the oxygen sensitive plastic allows multiple readings to be taken and have useable oxygen sensitive life spans that can be measured in years in appropriate environments. Neither the oxygen nor the sensor material is consumed in each reading. The improved photostability of such material and packages provides sensor systems that have longer life spans.

According to the present disclosure, an oxygen sensitive polymeric material with enhanced photostability, comprising an oxygen sensitive indicator and photostabilizer incorporated into an oxygen permeable polymeric material is provided. The oxygen sensitive indicator is but not limited to [Ru(L1)(L2)(L3)]²⁺, wherein Ru represents the central ruthenium ion, L1, L2 and L3 represent the bidentate ligands diphenylphenanthroline, phenanthroline or bipyridine ligands or optionally substituted variations of same with representative counter ions selected from (PF6)—, Cl—, BF4—, Br— and (C104)—, platinum or palladium based metallo-porphyrin. The photostabilizers that can be used include CIBA TINUVIN 5236, TINUVIN 292, TINUVIN 123 and TINUVIN 272, TINUVIN 477W, DABCO and ascorbic acid. The polymeric material can include, but is not limited to polyolefins, vinyl resins, polyamides, polyurethanes, fluoroplastics and polydimethylsiloxanes.

The oxygen sensitive indicator and photostabilizer may be incorporated by dissolving at least one oxygen sensitive indicator into at least one solvent. Also, incorporating oxygen sensitive indicator and photostabilizer may be accomplished by adding at least one oxygen sensitive indicator and at least one photostabilizer in powder form to at least one milled oxygen permeable polymeric material.

Similarly, the oxygen sensitive indicator and photostabilizer may be incorporation by the preparation of an oxygen sensitive masterbatch into an oxygen permeable polymeric material, where the masterbatch consists of a carrier resin doped with at least one oxygen sensitive indicator and at least one photostabilizer.

Oxygen sensitive material can be used in various packaging structures. For example, the oxygen sensitive material may be incorporated in a layered packaging structure that may include, for example a barrier layer.

To detect oxygen using the oxygen sensitive material according to the present disclosure, a sensor system may be used. The sensor system according to the present disclosure includes an excitation source, a oxygen sensitive polymeric material comprising of at least one oxygen sensitive indicator and at least one oxygen permeable polymeric material and a detector for capturing light emitted from said oxygen sensitive polymeric material.

A method for detecting oxygen in a package is provided. The method for detecting oxygen in a package includes the steps of interrogating the oxygen sensitive polymeric material with an LED, detecting light emitted from the oxygen sensitive polymeric material and calculating amount of oxygen present in said package.

### BRIEF DESCRIPTION OF THE DRAWINGS

The objects and features of the present disclosure are set forth with particularity in the appended claims. The present disclosure, as to its organization and manner of operation, together with further objectives and advantages may be understood by reference to the following description, taken in connection with the accompanying drawings, in which:

FIG. 1 is a chart showing the phase shift used for calculating concentration of oxygen in accordance with the present disclosure;

FIG. 2 depicts interrogation of a possible structure incorporating the oxygen sensitive plastic in accordance with the present disclosure;

FIG. 3 depicts detection of irradiated light from a possible structure incorporating the oxygen sensitive plastic in accordance with the present disclosure; and

FIG. 4 is a graph showing a comparison of the loss of signal to reference due to photobleaching of the normal and photostabilized sensors.

### DETAILED DESCRIPTION OF EXEMPLARY EMBODIMENTS

The present disclosure relates to the manufacture of oxygen sensing material by the incorporation, impregnation or mixing of oxygen sensitive indicators in polymeric material. Oxygen sensitive plastics are made, for example, by immobilizing ruthenium complex based dyes directly into a variety of polymers which can be used as an individual sensor or can be used as a sensitive layer within a laminated construction.

It is proposed that the oxygen sensitive material and methods described may be used for a variety of different applications. The oxygen sensitive material with improved photostability may be used to non-invasively detect and measure concentrations of oxygen in enclosed spaces, including gases enclosed in MAP packages containing items including, but not limited to, liquids, gases, food, cosmetics, medical devices and pharmaceuticals.

The manufacture of the oxygen sensitive polymeric material occurs through the incorporation or impregnation of oxygen sensitive indicators in polymeric material. The incorporation or impregnation of oxygen sensitive indicators in polymeric material can be accomplished by mixing and impregnation methods including use of solvents, powders, melts, and/or a masterbatch each of which are described below. In order to produce material with improved photostability, at least one photostabilizer was added at the point of introduction of the oxygen sensitive chemical indicator. A combination of the processes may also be used to make the oxygen sensitive plastic according to the present disclosure.

A variety of polymeric materials and oxygen sensitive chemical indicators may be used in accordance with the present disclosure. Examples of oxygen insensitive starting polymeric materials include, but are not limited to polyolefins, fluorinated polyolefins, ionomers, vinyl resins, polyamides, polyurethanes, fluoroplastics, polydimethylsiloxanes, polysiloxanes, acrylic polymers, methacrylic polymers, metallocene catalysed polymers and co-polymers of mentioned.

Oxygen sensitive chemical indicators that may be used in accordance with the present disclosure include, but are not limited to [Ru(L1)(L2)(L3)]²⁺, wherein Ru represents the central ruthenium ion, L1, L2 and L3 represent the bidentate ligands diphenylphenanthroline, phenanthroline or bipyridine ligands or optionally substituted variations of same with representative counter ions including but not limited to (PF6)—, Cl—, BF4—, Br— and (C10₄)—, and platinum or palladium based metallo-porphyrins. A number of compounds may be added to improve the photostability of these complexes in the polymer matrix.

In order to extend the workable shelf life of the oxygen sensing material, a photostabilizer may be added at the point of introduction of the oxygen sensitive indicator. These photostabilizers work either by the quenching of singlet oxygen by hindered amines (HALs) which is assumed to proceed via formation of an intermediate partial charge transfer complex, due to the lone electron pair on the amine or by shielding the complex from UV light by absorbing it (UV absorbers). In order for the photostabilizers to work efficiently, they have to be used in the correct ratio. It was determined for this application that the most effective ratio was between 3% and 10% of photostabilizer to the amount of the oxygen sensitive indicator in the plastic. Examples of suitable photostabilizers include, but are not limited to TINUVIN 123, TINUVIN 292, TINUVIN 5236 and TINUVIN 477DW.

Using solvent for the incorporation or impregnation of the oxygen sensitive chemical compounds and photostabilizer into the polymeric starting materials involves the dissolution of the oxygen sensitive chemical indicator and photostabilizer into a suitable solvent. The solvent is then introduced to the polymeric starting material with mixing, resulting in a homogenous coating of the oxygen sensitive chemical compound and photostabilizer on the polymeric starting material. Suitable solvents for the incorporation of both the oxygen sensitive chemical compounds and photostabilizers into the polymeric starting material include, but are not limited to ethanol, methanol, water, ethyl acetate, isopropanol or mixtures of same.

The oxygen sensitive chemical indicator and photostabilizer can also be introduced into the polymer starting material in powder form. Typically, for this method to be successful, it is necessary that the polymeric starting materials be milled prior to the introduction of the powdered oxygen sensitive chemical indicator and photostabilizers. After milling, the oxygen sensitive chemical indicator and photostabilizers is introduced and the mixture stirred until the oxygen sensitive chemical indicator and photostabilizers is homogenously distributed throughout the polymeric starting material.

Additionally, the oxygen sensitive chemical indicator and photostabilizers can be introduced into the polymeric materials after these polymeric materials have melted. A homogenous distribution of the dye material and photostabilizers throughout the polymer melt can be achieved with the correct mixing of the melted polymer.

A masterbatch can also be prepared. A masterbatch is a preparation of a concentrated uniform dispersion of the oxygen sensitive chemical indicator and photostabilizers in plastic pellets, most commonly in small granular shape with good shape consistency in order to achieve the proper concentration and dispersion of the oxygen sensitive indicator. A masterbatch is prepared in a carrier resin compatible with the dilution resins of the polymers which make up the bulk of the oxygen sensitive finished product. The carrier must have the necessary oxygen permeability that is also required in the dilution resin.

According to the present disclosure, a masterbatch is a concentrated mixture of the oxygen sensitive chemical indicator and photostabilizers which is encapsulated during a heat process into a carrier resin which is then cooled and cut into a granular shape. These concentrated doped granules can then be used to manufacture the desired product. The concentrated granules can be added to specific amounts of starting polymeric materials in order to achieve an overall concentration of the oxygen sensitive indicator and photostabilizers in the bulk mixture.

The masterbatch is prepared by either pre-mixing or split-feed processes. In the split-feed process, the polymer is metered into the upstream portion of the twin-screw extruder. After it has been melted, oxygen sensitive chemical indicators and photostabilizers are fed via a twin-screw side-feeder into the extruder. Here, only gravimetric feeders are used. In the split-feed process, the amount of the oxygen sensitive chemical indicator can be up to 60% of the overall masterbatch mixture. These doped masterbatch pellets consist of an oxygen permeable polymer carrier such as polyolefins, polymethylmethacrylate, co-polymers of same, additives such as wax, ultra violet stabilizers, antifog agents, the oxygen sensitive chemical indicators and photo stabilizers in question.

In the premix process, all the components are mixed in one mixer and then conveyed via a volumetric feeder into the twin-screw extruder. In this premix process, the amount of the oxygen sensitive indicator may be approximately 20-40% of the overall masterbatch mixture consist of an oxygen permeable polymer carrier such as polyolefins, polymethylmethacrylate, co-polymers of same, additives such as wax, ultra violet stabilizers, antifog agents, the oxygen sensitive chemical compounds and photostabilizers in question.

Processing of the doped bulk polymeric carrier, where doping has been achieved by masterbatch pellets, solvent impregnation or powder addition of the oxygen sensitive indicator are all carried out as described below.

For polypropylene, the temperature profile for between the hopper and the die is typically between 180-230° C. For extruded polyethylene, the temperature profile is typically 170-200° C. For extruded polystyrene, the temperature profile is generally 180-230° C. In the case of any of the above mentioned polymers with a very high mass flow index (MFI), the temperature parameters mentioned above are approximately 10° C. lower than for the lower MFI counterparts. Pressure is typically not a parameter to be pre-set before the extrusion process.

Once, the oxygen sensitive chemical indicator or indicators and photostabilizers are incorporated into the polymeric mixture, the oxygen sensitive plastic can be manufactured in a variety of different ways depending on the desired end product. End products include films, sheets, and molded plastics of any shape. The oxygen sensitive plastic can be used directly as an oxygen sensor, as oxygen sensitive packaging materials, or as an oxygen sensitive layer within a laminate construction. End-product forming methods, include but are not limited to, sheet extrusion, blow extrusion, cast extrusion, injection molding, thermoforming, compression and transfer molding and any other method of polymer production for commercial use.

The oxygen sensitive plastic according to the present disclosure may be utilized in a variety of structures. The oxygen sensitive plastic may be used in conjunction with other materials such as lamination adhesives, polymers or other barrier layers, reflective layers, absorption material layers and scavenger material layers to form the final laminate structure that will be used in the packaging application.

Lamination adhesives, for example, may be two component, solvent borne adhesives based on polyurethane; two component water dispersed urethane adhesive, acrylic based lamination adhesives (waterborne and solvent borne), or styrene butadiene co-polymer based adhesives. For short term applications, suitable barrier materials that may be used in accordance with the present disclosure include but are not limited to polyethylene terephthalate, under the trade name Mylar©, polyvinylidene chloride under the trade name Saran©, or oriented nylon.

For long-term applications, suitable barrier materials include, but are not limited to transparent films based on vacuum deposited ceramics, Escal™ and PTS films by Mitsubishi Gas Chemicals; fluoropolymers, Chlorortrifluoroethylene, trade name Aclar© or ethylene vinyl alcohols (EVOH).

Once the oxygen sensitive plastic is in the desired end product, it may be used in an optical oxygen sensing system. The concentration of oxygen can be non-invasively measured within an enclosed atmosphere, such as that within a sealed package, bottle or vial by interrogation of the oxygen sensitive plastic with an excitation beam and subsequent analysis of the irradiated light. The generation of the excitation beam, collection of the irradiated beam and subsequent analysis yields the oxygen concentration and may be accomplished using a single opto-electronic mobile hand held analyzer.

The oxygen sensitive plastic as described above may consist of an oxygen-sensitive luminophore such as [RuII-Tris(4,7-diphenyl-1,10-phenanthroline)]²⁺, referred to as [Ru(dpp)3]2+, as previously described, immobilised in an oxygen-permeable plastic. Upon illumination or excitation of the luminophore by light of a suitable wavelength, the complex absorbs photons of light and an electron is within the complex is excited to a higher energy level. The excited-state lifetime refers to the average time the luminophore remains in this excited state. Naturally, the luminophore returns to its ground state with the emission of a photon of light.

Should the emitted photon of light from the luminophore collide with an oxygen molecule, the photon looses its energy through formation of an exciplex. In this instance, the luminophore returns to ground state without the emission of a photon and so the observed luminescence is effectively quenched. Since the extent of quenching is proportional to the quantity of oxygen molecules present this process can be exploited as a sensing mechanism. Essentially, measuring the duration of the excited-state lifetime measures the oxygen concentration.

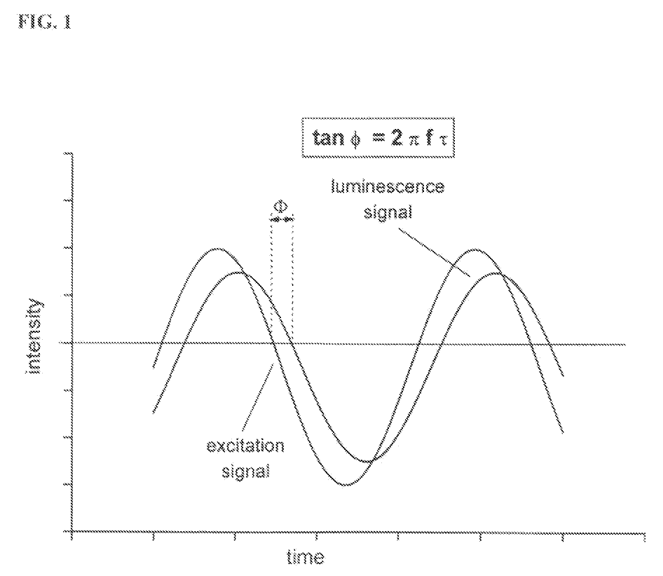

This phenomenon is exploited by using the excited-state lifetime which we measure via phase fluorometry. This phenomenon is shown in FIG. 1. If the excitation signal is sinusoidally modulated, the luminophore's luminescence is also modulated but is time delayed or phase shifted relative to the excitation signal. The relationship between the excited-state lifetime, τ, and the corresponding phase shift, Φ, for a single exponential decay is:

$$τ = \frac{tan φ}{2 π f}$$

where, f is the modulation frequency. This phase shift is illustrated in FIG. 1.

Electronics used may be, for example, a blue light emitting diode (LED), such as that provided by Nichia under catalog number NSPB500S, as the excitation source. The detector may be a silicon photodiode such as that provided by Hammamatsu™ under catalog number S1223-01. The phase shift is recovered from the optical signal via a phase-lock loop circuit. The optoelectronic and electronic components may be housed in a device such as the GSS 450 Oxygen Analyser™.

The oxygen sensitive plastic may be incorporated within a multi-layered laminate packaging film or material to non-invasively measure the concentration of oxygen within an enclosed atmosphere such as that within a sealed environment. The laminate material can act simultaneously as both an oxygen sensor for the enclosed atmosphere and as an oxygen barrier to restrict the movement of oxygen from outside the package inwards and vice versa. This construction may have single or multiple layers of some or all of the oxygen sensitive plastic according to the present disclosure, lamination adhesive, polymer or other barrier layers, reflective layers, absorption material layers and/or scavenger material layers.

Laminate multiple layers can be formed by reel-to-reel lamination of each layer in such a way that lamination adhesive is applied on the polymeric film being that oxygen sensitive polymeric film, barrier film and/or reflective layer film. Lamination adhesive can be applied using roll, knife, and rod coating.

The laminate part consisting of barrier film and oxygen sensitive polymeric film can be alternatively made by co-extrusion. Co-extruded laminate of oxygen polymeric film and barrier film can then be laminated with a reflective layer film using the lamination technique described above.

An absorption layer can be made as a polymer solution doped with absorption molecules. The solution can be then deposited on the rest of the laminate film by rod, roll, knife coating or gravure printing.

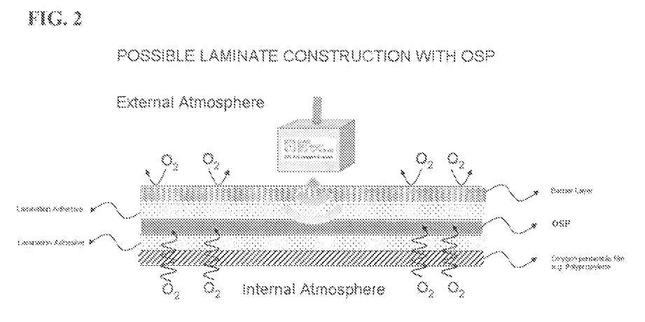

FIG. 2 shows the interrogation of the oxygen sensitive plastic layer by the blue LED from an optical head. The optical head such as the GSS 450 Oxygen Analyser™ includes the electronics for interrogation and detection of subsequent emitted light. The laminate structure shown in FIG. 2 includes a barrier layer, a layer of oxygen sensitive plastic according to the present disclosure, a layer of oxygen permeable film such as polypropylene and two lamination layers. The optical head includes a blue LED which interrogates the oxygen sensitive plastic layer.

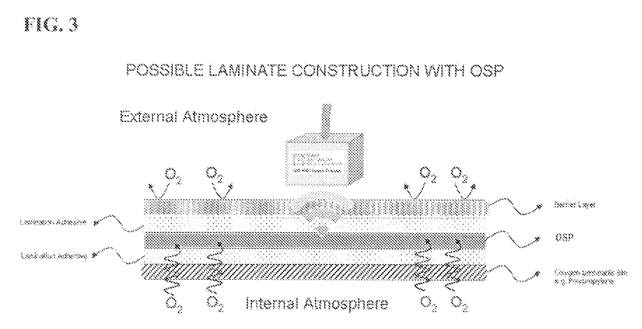

FIG. 3 shows the subsequent analysis of the irradiated orange light from the oxygen sensitive plastic according to the present disclosure. This irradiated orange light is subsequently detected by the optical head which includes a detector. Oxygen concentration is then determined.

### EXAMPLES

### Incorporation of Oxygen Sensitive Material

### Example 1

### Formulation of Oxygen Sensitive Masterbath Without Photostabilization by Pre-Mixing

1 g of Ru-tris (4,7-diphenyl-1,10-phenanthroline) dichloride (0.1%-wt of an overall mixture) was added to 20 g of powdered polypropylene PP (Total Petrochemicals PPC 5660) which had been pre-ground in a Wedco single stage grinding Mill. The mixture of powders was mixed in a Caccaia High Speed Turbomixer until homogeneity was achieved. The homogenous powder mixture is introduced to a small twin extruder/compounder at 210° C. (Dr Collin Twin Screw Compounder) to produce master batch pellets. These master batch pellets were used to compound the bulk polymer matrix.

### Example 2

### Formulation of Photostabilized Oxygen Sensitive Masterbath by Pre-Mixing

A mixture of 1 g of Ru-tris (4,7-diphenyl-1,10-phenanthroline) dichloride (0.1%-wt of an overall mixture) and 0.05 g of TINUVIN 5236 was added to 20 g of powdered polypropylene PP (Total Petrochemicals PPC 5660). The polypropylene was pre-ground in a Wedco single stage grinding Mill. The mixture of powders was mixed in a Caccaia High Speed Turbomixer until homogeneity was achieved. The homogenous powder mixture is introduced to a small twin extruder/compounder at 210° C. (Dr Collin Twin Screw Compounder) to produce master batch pellets. These master batch pellets were used to compound the bulk polymer matrix.

### Example 3

### Formulation of Oxygen Sensitive Masterbath Without Photostabilization by Split-Feed Process

1 g of Ru-tris (4,7-diphenyl-1,10-phenanthroline) dichloride (0.1%-wt of an overall mixture) 0.05 g of was introduced via a twin-screw side-feeder into the main polymer melt (10 g polypropylene PP(PP S40J)) at 200° C. The machine used to produce master batch pellets was a Dr Collin Twin Screw Compounder. These master batch pellets were used to compound the bulk polymer matrix.

### Example 4

### Formulation of Photostabilized Oxygen Sensitive Masterbath by Split-Feed Process

A mixture of 1 g of Ru-tris (4,7-diphenyl-1,10-phenanthroline) dichloride (0.1%-wt of an overall mixture) and 0.05 g of TINUVIN 5236 was introduced via a twin-screw side-feeder into the main polymer melt (10 g polypropylene PP(PP S40J)) at 200° C. The machine used was a Dr Collin Twin Screw Compounder to produce master batch pellets. These master batch pellets were used to compound the bulk polymer matrix.

### Example 5

### Formulation of Oxygen Sensitive Masterbath Without Photostabilization by Impregnation

1 g of Ru-tris (4,7-diphenyl-1,10-phenanthroline) dichloride (0.1%-wt of an overall mixture) g of was dissolved in 20 ml of ethyl acetate and 10 ml of isopropanol. This solution was poured over 20 g of pre-milled powdered polypropylene PP (Total Petrochemicals PPC 5660), ground with a Wedco Single Stage Grinding Mill and stirred. After proper mixing was achieved, the mixture is allowed to sit until the solvents evaporated. The compounded polymer was then fed into a twin extruder (such as Dr Collin Twin Screw Compounder) to produce master batch pellets. These master batch pellets were used to compound the bulk polymer matrix.

### Example 6

### Formulation of Photostabilized Oxygen Sensitive Masterbath by Impregnation

A mixture of 1 g of Ru-tris (4,7-diphenyl-1,10-phenanthroline) dichloride (0.1%-wt of an overall mixture) and 0.05 g of TINUVIN 5236 was dissolved in 20 ml of ethyl acetate and 10 ml of isopropanol. This solution was poured over 20 g of pre-milled powdered polypropylene PP (Total Petrochemicals PPC 5660), ground with a Wedco Single Stage Grinding Mill and stirred. After proper mixing was achieved, the mixture is allowed to sit until the solvents evaporated. The compounded polymer was then fed into the twin extruder Dr Collin Twin Screw Compounder to produce master batch pellets. These master batch pellets were used to compound the bulk polymer matrix.

### Example 7

### Formulation of Oxygen Sensitive Plastic Precursors Without Photostabilization for the Extrusion Process

0.5 g of Ru-tris (4,7-diphenyl-1,10-phenanthroline) dichloride (0.1%-wt of an overall mixture) 0.025 was added to 500 g of pre-milled powdered polypropylene PP(Total Petrochemicals PP S40J). The powders were placed in the mixing chamber of a Caccia High Speed Turbomixer and thoroughly mixed to produce a homogenous powder mixture.

### Example 8

### Formulation of Photostabilized Oxygen Sensitive Plastic Precursors for the Extrusion Process

A mixture of 0.5 g of Ru-tris (4,7-diphenyl-1,10-phenanthroline) dichloride (0.1%-wt of an overall mixture) and 0.025 g of TINUVIN 5236 was added to 500 g of pre-milled powdered polypropylene PP(Total Petrochemicals PP S40J). The powders were placed in to a mixing chamber of Caccia High Speed Turbomixer and thoroughly mixed to produce a homogenous powder mixture.

### Extrusion

### Example 9

### Extrusion of Oxygen Sensitive Plastic Raw Polymer Powder Mixture Without Photostabilization

The non-photostabilized oxygen sensing powder mixture from Example 7 was placed in the blow extrusion hopper of a blow extruder (Two Killon K150 with 25 mm screw) and processed at 210° C. at constant pressure. The speed of the machine was 10 rpm with haul off of 20 m/min. By varying these parameters this production technique allows O2 sensing films to be extruded from 10 μm to 200 μm.

### Example 10

### Extrusion of Photostabilized Oxygen Sensitive Plastic Raw Polymer Powder Mixture

The photostabilized oxygen sensing powder mixture from Example 8 was placed in the blow extrusion hopper of a blow extruder (Two Killon K150 with 25 mm screw) and processed at 210° C. at constant pressure. The speed of the machine was 10 rpm with haul off of 20 m/min. By varying these parameters this production technique allows O2 sensing films to be extruded from 10 μm to 200 μm.

### Example 11

### Extrusion of Oxygen Sensitive Plastic Masterbatch Without Photostabilization

Masterbatch pellets from either Example 1, 3, or 5 are mixed with a polymer carrier (e.g. PP S 403) and placed into the hopper of a blow extruder (e.g. Two Killon K150 extruder with 25 mm screw) and processed at 210° C. at constant pressure. The speed of the machine was 10 rpm with haul off of 20 m/min. By varying these parameters this production technique allows O2 sensing films to be extruded from 10 μm to 200 μm.

### Example 12

### Extrusion of Photostabilized Oxygen Sensitive Plastic Masterbath

Masterbatch pellets from either Example 2, 4, or 6 are mixed with the polymer carrier (e.g. PP S 40J) and placed into the hopper of a blow extruder (e.g. Two Killon K150 extruder with 25 mm screw) and processed at 210° C. at constant pressure. The speed of the machine was 10 rpm with haul off of 20 m/min. By varying these parameters this production technique allows O2 sensing films to be extruded from 10 μm to 200 μm.

### Studies and Results

The photostability of the oxygen sensitive polymeric materials in question were studied using a GSS 450 Oxygen Analyser™. This equipment consisted of two channels, a reference channel and a signal channel. The two channels consisted of identical electrical components. The reference channel was used to compensate for any temperature changes that the electronic unit is subjected to. The phase angle of the signal channel was the measured phase difference between the sinusoidally modulated excitation signal and the resultant fluorescent signal which is phase shifted with respected to the excitation signal and is dependent on oxygen concentration. The phase angle of the reference channel is the measured phase difference between the sinusoidally modulated excitation signal and the resultant fluorescent signal from the LED which is phase shifted with respected to the excitation signal and is dependent on temperature. The phase signals (signal and reference) were fed into a phase detector and processed. A control experiment was carried out to demonstrate that the changes in signal to reference being observed in the following experiment are due to illumination and subsequent photobleaching of the oxygen sensitive polymeric material, the results are presented in Table 1. The sensor when stored in the dark over the same 72 hour period of the experiment exhibited no change in the signal to reference value recorded with the GSS 450 Oxygen Analyser™.

TABLE 1

| | Change in signal to reference |
|---|---|
| Time in the dark t/hrs | values (a.u.) |
| 0 | — |
| 2 | 0.0 |
| 3 | 0.0 |
| 4 | 0.0 |
| 6 | 0.0 |
| 72 | 0.0 |

### Sensitive of the Oxygen Sensors to Light Without the Introduction of a Photostabilizer

Samples of the plastic materials from Example 9 and 11 to be tested were cut into 2 cm×2 cm squares and placed into a flow cell. The flow cell was then flushed with 100% N₂. Once the gases within the flow cell had equilibrated at 100% N₂, a signal to reference value reading was taken with the GSS 450 Oxygen Analyser™.

The samples were then removed from the flow cell and exposed to a laboratory light source in order to investigate the photodegradation of the dye within an extruded polymer matrix. The power of the lab light was measured using a Solar Light Testing™—dose control system to be 1 W/m².

The samples were exposed to the laboratory light source for varying amounts of time. The effect of the varying doses on the readings were tracked by replacing the samples into the flow-cell and taking measurements under nitrogen with the GSS 450 Oxygen Analyser™ at periodic intervals. Table 1 below tracks the changes in the signal to reference of a sensor which has been exposed to light for varying amounts of time.

TABLE 2

| Time of exposure to the lab | Change in Signal to reference |
|---|---|
| light/hrs | values (a.u.) |
| 0 | — |
| 2 | −4.4 |
| 3 | −7.04 |
| 4 | −9.37 |
| 6 | −13.84 |
| 72 | −22.31 |

Table 2 shows recorded changes in signal to reference value for sensors without photostabilizer made in accordance with the methodology of example 9 due to varying exposures to light. Table 1 shows that the exposure to light causes a decrease in the signal to reference values of the exposed sensor, inferring that the emissive dye molecule was being photobleached, which is turn was leading to a reduction in the oxygen concentration value being recorded by the GSS 450 Oxygen Analyser™. This reduction causes an error in the recorded value, as the changes are not due to changes in the atmosphere (all measurements were made at 100% N2), rather the changes are due to a photobleaching effect caused by the exposure of the sensors to the laboratory light source.

### Sensitivity of the Oxygen Sensors to Light After the Introduction of a Photostabilizer

Again, the photostability of the sensor materials in question were studied using a GSS 450 Oxygen Analyser™. Samples of the plastic materials made in accordance with example [10] to be tested were cut into 2 cm×2 cm squares and placed into a flow cell. The flow cell was then flushed with 100% N₂. Once the gases within the flow cell had equilibrated at 100% N₂ a reading was taken with the GSS 450 Oxygen Analyser™. The signal to reference value was recorded at 100% N2.

The samples were then removed from the flow cell and exposed to the laboratory light source in order to investigate the effect of light on the photodegradation of the dye within an extruded polymer matrix. Again, the power of the lab light was measured using a Solar Light Testing—dose control system to be 1 W/m².

The samples were exposed to the laboratory light source for varying amounts of time. The effect of the varying doses on the readings were tracked using the flow-cell and GSS 450 Oxygen Analyser. Table 3 below tracks the changes in the signal to reference values.

TABLE 3

| | Change in signal to reference |
|---|---|
| Time of exposure to the lab | values (recorded on GSS450 |
| light/hrs | O2 Analyser) |
| 0 | — |
| 2 | −3.9 |
| 25 | −7.5 |
| 67 | −11.4 |
| 187 | −18.8 |
| 432 | −25.5 |

Table 3 shows recorded changes in the signal to reference values recorded for the sensors containing photostabilizer due to varying exposure to light. As with the results in Table 2, the samples showed photodegradation features. However, the rate of degradation is much slower in this instance, most notably at longer exposure times, where the rate of photodegradation was over 6 times slower than in case of oxygen sensing extruded polymer without photostabilizer.

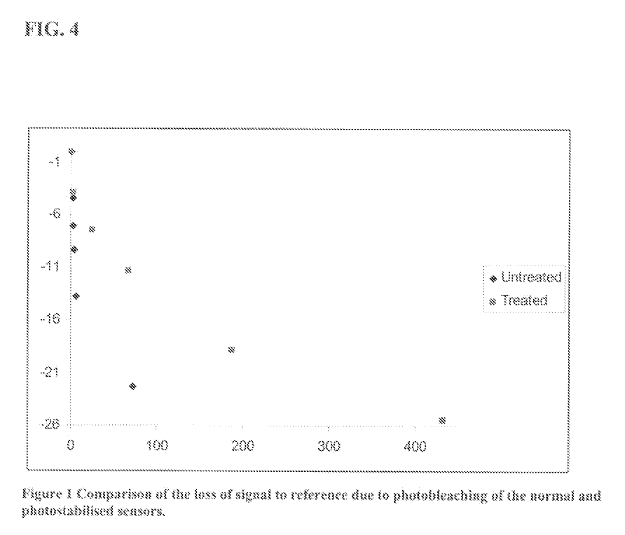

FIG. 4 shows a comparison of the changes in the signal to reference values recorded for the sensor stored in the dark, that with no photostabilizer and that which did contain photostabilizer. While initially the responses were similar, major differences became apparent after as little as 6 hours exposure. At this point, the rate at which sensors which have been produced with photostabilizer continued to lose signal, slowed appreciably, whereas the rate of photobleaching for the untreated sensors continued unabated.

These results point to the effectiveness of adding photostabilizers to the oxygen sensors in order to improve the long term photostability of the finished sensor. This experiment highlights a 6-fold improvement in the loss of signal over time for the sensor containing photostabilizer versus that without.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. An oxygen sensitive polymeric material with enhanced photostability, comprising an oxygen sensitive indicator and photostabilizer incorporated into an oxygen permeable polymeric material.

2. The oxygen sensitive polymeric material of claim 1, wherein the oxygen sensitive indicator is [Ru(L1)(L2)(L3)]²⁺, wherein Ru represents the central ruthenium ion, L1, L2 and L3 represent the bidentate ligands diphenylphenanthroline, phenanthroline or bipyridine ligands or optionally substituted variations of same with representative counter ions selected from (PF6)—, Cl—, BF4—, Br— and (C104)—, platinum or palladium based metallo-porphyrin.

3. The oxygen sensitive polymeric material of claim 1, wherein the photostabilizer is selected from CIBA TINUVIN 5236, TINUVIN 292, TINUVIN 123 and TINUVIN 272, TINUVIN 477W, DABCO and ascorbic acid.

4. The oxygen sensitive polymeric material of claim 1, wherein said oxygen permeable polymeric material, is selected from polyolefins, vinyl resins, polyamides, polyurethanes, fluoroplastics and polydimethylsiloxanes.

5. The oxygen sensitive polymeric material of claim 1, wherein the oxygen sensitive indicator and photostabilizer are incorporated by dissolving at least one oxygen sensitive indicator of claim 2 and at least one photostabilizer of claim 3 into at least one solvent.

6. The oxygen sensitive polymeric material of claim 1, wherein the oxygen sensitive indicator and photostabilizer are incorporated by adding at least one oxygen sensitive indicator of claim 2 and at least one photostabilizer of claim 3 in powder form to at least one milled oxygen permeable polymeric material of claim 4.

7. The oxygen sensitive polymeric material of claim 1, wherein the oxygen sensitive indicator and photostabilizer are incorporated by the incorporation of an oxygen sensitive masterbatch into an oxygen permeable polymeric material of claim 4, where the masterbatch consists of a carrier resin doped with at least one oxygen sensitive indicator of claim 2 and at least one photostabilizer of claim 3.

8. An oxygen sensitive structure comprising:
at least one layer of oxygen sensitive polymeric material from claim 1; and
at least one other layer.

9. The oxygen sensitive structure of claim 8 further comprising at least one barrier layer.

10. An optical oxygen sensor system comprising:
an excitation source;
a oxygen sensitive polymeric material of claim 1 comprising of at least one oxygen sensitive indicator of claim 2 and at least one oxygen permeable polymeric material of claim 4; and
a detector for capturing light emitted from said oxygen sensitive polymeric material.

11. A method for detecting oxygen in a package comprising:
interrogating the oxygen sensitive polymeric material from claim 1 with an LED;
detecting light emitted from said oxygen sensitive polymeric material; and
calculating amount of oxygen present in said package.
